(19) United States
(12) Patent Application Publication
(10) Pub. No.: US 2026/0258696 A1
(43) Pub. Date: Sep. 3, 2026

(54) VACUUM INSULATED GLASS PANEL WITH MICRO VACUUM VALVE MOUNTED

(71) Applicant: Yung Jae CHOI, Paju-si (KR)

(72) Inventor: Yung Jae CHOI, Paju-si (KR)

(21) Appl. No.: 19/067,152

(22) Filed: Feb. 28, 2025

(51) Int. Cl. E06B 3/677; E06B 3/66; F16K 99/00

(52) U.S. Cl. CPC E06B 3/677; E06B 3/6612; F16K 99/0005

(57) ABSTRACT

Provided is a vacuum insulated glass (VIG) panel with a micro vacuum valve (MVV) mounted. The VIG panel includes two glass substrates spaced apart by a predetermined distance and periphery hermetically welded with the glass strip walls define the vacuum space wherein a module disposed therebetween; the module comprises glass strips and the glass strip walls as unit and disposed between said glass substrates ; and a micro vacuum valve (MVV) pre-mounted in the vacuum space through the hole either at the corner of the first glass substrate or at the glass strip wall. The vacuum space is evacuated to 10⁻³ Torr or less by connecting vacuum pump hose adapter to the MVV; and with the wide vacuum gap, U-value reaches 0.1 W/m² K or less. And it is possible to supply VIG panels to meet market demand huge quantity thanks to the MVV and the module that simplify production processes.

### FIELD OF THE INVENTION

The present invention relates to a vacuum insulated glass (VIG) panel and methods of making the same. The panels are used for glazing, greenhouse, building wall, noise barrier, refrigerator door, and other applications. More particularly, the present invention relates to a VIG panel with a micro vacuum valve (MVV) mounted in the vacuum space for the cold evacuation wherein two spaced apart glass substrates are periphery interconnected with a rectangular glass strip wall by laser welding and glass strips as spacer are disposed between two glass substrates to support vacuum pressure.

### BACKGROUND OF THE INVENTION

Vacuum Insulated glass (VIG) panel is disclosed in U.S. Pat. Nos. 10,443,298 and 10,443,299 (Chin) titled “VACUUM INSULATED GLASS PANEL WITH STRUCTURED PILLAR UNIT.” These patents introduce a structured pillar unit designed to support vacuum pressure and a vacuum miniature piston valve (VMPV) for evacuating the vacuum space.

Through the VMPV, cold evacuating method can be applied so that it does not necessarily use furnace as in their prior art that was one of the biggest obstacles in the process of making VIG units.

Also, it is possible to use tempered glass substrate which has high flexural and tensile strength that is a great advantage because it reduces the number of spacers.

Even for some sizes and/or shapes, spacers are not required at all for the certain thickness of glass sheet.

Nevertheless, the structured pillar unit is complicate; the VMPV exposes some drawbacks such that it leaks momentarily upon disconnecting the vacuum hose adapter from the valve; and still many pillars are arrayed with distances of 120 to 180 mm or 140-220 mm that may not be an optimum solution when pillars to be used as spacer to support high vacuum pressure in the VIG panel.

But it cannot be denied that prior art has opened new chapter in VIG industries and that is hereby incorporated herein by reference.

### SUMMARY OF THE INVENTION

In the present invention, disadvantages of the prior art—such as the complicated structured pillar unit, functional issues in the VMPV, the presence of numerous pillars, which was one of the biggest obstacles in manufacturing VIG panels, and multilayer sealings—are addressed by replacing them with a module, an MVV for vacuum evacuation, glass strips as spacers, and laser welding, respectively.

Thanks to aforesaid novel features, lifetime quality can be guaranteed, and mass production ensures supply at affordable price.

And U-value may be reduced to about 0.1W/m² K or less in the vacuum gap of 24 mm at 10⁻³ Torr or less in the vacuum space.

This invention was possible by applying the instrument of measuring bending shapes of the glass substrates onto the glass strips by vacuum pressure.

The aforesaid instrument is provided by inventor and naturally the embodiments are tested with actual specifications and vacuum level in field condition.

Present invention does not provide the general solution for the array of glass strips or pillars to support vacuum pressure. But only if all kind of necessary specifications for VIG Panel and of which shapes are given then solutions can be provided.

### BRIEF DESCRIPTION OF THE DRAWINGS

FIG. 1 is a cross-sectional view of the VIG Panel of FIG. 2 taken along section line I-I.

FIG. 2 is a transparent top plane view of VIG panel size of 2100 mm by 930 mm.

FIG. 3 is a perspective view of a module comprising two parallel glass strips and two vertical glass strips crossed each other as lattice structure; and which are interposed in a rectangular glass strip wall.

FIG. 4 is a perspective view of the glass strip side wall with both sides beveled.

FIG. 5 is a side view of the glass strip which has feet tapered toward both ends as dotted ellipse 51, and u-shaped slit to fit crossing each other with inverted u-shaped slit, and Low-E film 8 is bonded onto the feet of glass strip and onto the other side of glass strips.

FIG. 6 is a cross-sectional view of MVV mounted through the hole at the corner in the first glass substrate into the vacuum pace.

FIG. 7 is a cross-sectional view of air flows in the evacuating process and an opening vacuum gate in the MVV.

### DETAILED DESCRIPTION OF THE INVENTION

The above features or other advantage of present invention will be more clearly understood through the following detailed descriptions taken in conjunction with the accompanying drawings.

Certain embodiments in this invention can be applied more practically in manufacturing VIG panel by the novel concepts as the evacuating vacuum valve 60 which is named here ‘Micro Vacuum Valve’; a welding peripheral enclosure 6; a glass strip side wall 3; glass strips 4={4a, 4b} as spacer; and an array of glass strips 4 by applying Pascal's principle in the vacuum space 11; and a method of making the same.

### Novel Embodiments of the Concepts

### 1. Glass Substrates

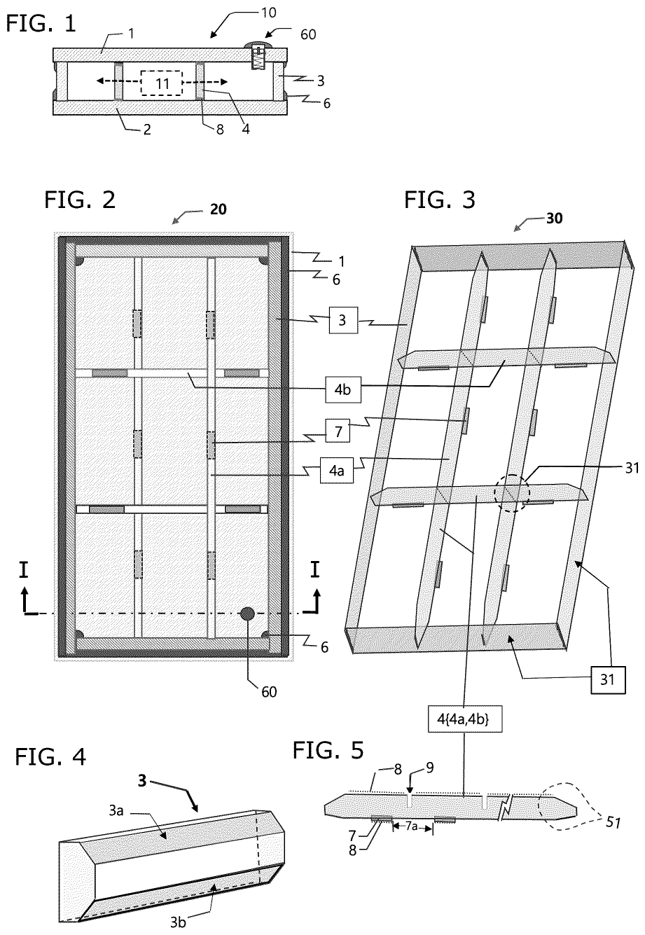

Referring to FIGS. 1 and 2, the first glass substrate 1 and second glass substrate 2 spaced apart compose the vacuum space 11 by interconnecting with the glass strip side wall 3 of the rectangular glass strip wall 31 by periphery welding define the vacuum space 11 wherein the glass strips 4 {4a, 4b} are disposed therebetween to support vacuum pressure.

The glass substrates 1, 2 are tempered of 4~6 mm thick; and dimension is 2100 mm by 930 mm.

The vacuum pressure against the first glass substrate 1, in the vacuum space 1 is about 1.95×10⁵ N in the said VIG panel at the vacuum level 10⁻³ Torr or less against the first glass substrate 1 also the same vacuum pressure against the second glass substrate 2.

The glass strips 4a, 4b and the rectangular glass strip side wall 31 composing a module disposed between the substrates 1, 2 should support vacuum pressure 3.9×10⁵ N at least.

The tempered glass substrate can be used safely because there is no use of furnace, that keeps its original character of high tensile and flexural strength.

Thus, a burden of large number of spacers can be eliminated owing to high strength of glass substrates 1, 2 that were the major obstacle of making VIG panel.

### 2. Glass Strips

Referring to FIG. 5, the glass strip 4 is tempered; both ends are tapered toward each end as dotted ellipse 51; and has feet 7 to facilitate air flow between them; and the vertical glass strips 4a are designed with u-shaped slit 9, and the parallel glass strips 4b are inverted u-shaped slit or vice versa to fit them to be cross joined perpendicularly and parallel each other as a lattice structure.

The feet 7 minimize contact area onto the second glass substrate 2 facing outside to reduce thermal transmission by reducing contact area.

The glass strip 4 is cut neatly by a water-jet machine and Low-E film 8 may be bonded onto foot 7 of glass strip and onto the other side of glass strip to buffer shock against the glass substrates 1, 2 from the vacuum pressure about 1.95×10⁵ N for the size 2100 mm by 930 mm of the VIG panel in aforesaid vacuum level while the glass strips 4{4a, 4b} are tapered toward both ends as dot circle 51 to prevent heat damage from welding.

The glass strips 4 are tempered and thickness is 4-6 mm; the width of the glass strips 4{4a, 4b} is equal to the gap of the vacuum space 11 i.e. 120-240 mm; the length of the foot 7 is 6-14 mm; the distance between feet 7a is 120 to 140 mm or more which is the air passage 7a for air flow; and depth of feet is 1.4~2 mm.

### An Array of Glass Strips as Spacers

Referring to FIG. 2, two vertical and two parallel glass strips 4a, 4b are arrayed in equal distances respectively.

Therefore, if the size of the VIG panel is 2100 mm high and 930 mm wide, then both the height and the width shall be divided into three equal sections in 700 mm by 310 mm by vertical and parallel, respectively.

One of the biggest obstacles among others in the VIG panel manufacturing may concern an array of spacers whether it is strips of glass or pillars.

This invention does not provide general solution for any array of spacers but only solution for the given specifications and shape of the VIG panel.

### 3. Glass Strip Side Wall

Referring to FIGS. 1, 2, 3 and 4, the glass strip side wall 3 is float glass such that thickness is 4-6 mm; and the height is equal to the gap of the vacuum space 11 i.e. 140-240 mm.

Both side of the width of the glass strip side wall 3a, 3b are beveled to expand welding area 6 for secure welding.

The MVV 60 may be pre-mounted through the hole in the glass strip side wall 3 instead of the first glass substrate 1. It has aesthetic value and packing advantage. But the vacuum space 11 cannot be re-evacuated. Cylinder 61 outside of the aforesaid valve 60 may be hermetically sealed with sealant then safety cap 68 is not necessary that save cost and time.

### 4. Module

Referring to FIG. 3, a module 30 is composed of two vertical and two parallel glass strips 4a, 4b respectively integrated into a lattice structure and set within the rectangular glass strip side wall 31.

The module 30 may be disposed between two spaced apart glass substrates 1, 2 in the vacuum gap of 14-24 mm; and joined with the rectangular glass strip side wall 31 by periphery welding to form the vacuum space 11.

The module 30 supports vacuum pressure about 3.9×10⁵ N in the size of VIG panel 2100 mm by 930 mm at 10⁻³ Torr or less in the vacuum space 11.

This modularization of glass strips 4 with the glass strips side wall 3 of the rectangular glass strip wall 31 as a module 30 could enable mass production and affordable pricing.

### 5. Micro Vacuum Valve (MVV)

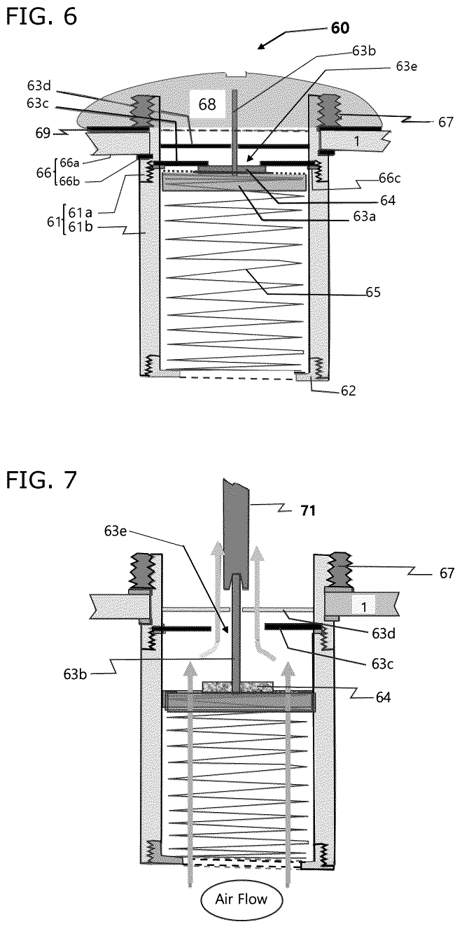

Referring FIG. 6, the micro vacuum valve 60 comprises a cylinder 61 comprising upper cylinder 61a and lower cylinder 61b; a tail threaded ring 62; a piston 63a; a piston shaft 63b; a vacuum gate plate 63c; a piston shaft guider 63d; a vacuum gasket F-217 64; a spring 65; a gasket ring 66c; inside and outside threaded ring 67; gasket ring 69; and a safety cap 68.

The reason why two cylinders 61a and 61b to be joined for the cylinder 61 is for the easy insert of vacuum gate plate 63c with gasket ring 66c into the cylinder 61.

The cylinder 61 of the MVV 60 has an inner diameter of 8-12 mm, a thickness of 3-4 mm, and high of 28-38 mm, and is exposed 5-8 mm outside the first glass substrate 1, and is secured by a threaded ring 67, so that when the vacuum pump adapter is connected to it, the piston shaft 63b can be pushed down sufficiently to open the vacuum gate 63e.

The MVV 60 mounted through the hole either at the corner of the first glass substrate 1 or the glass strip side wall 3, partially exposed outside, and secured by the threaded ring 67 which may be connected to the vacuum hose adapter to evacuate the vacuum space 11 up to 10⁻³ Torr or less.

Just before the vacuum hose adapter is disconnected, the gasket 54 might already had been shut by a spring force of 10 N or more, if the diameter of inside of the vacuum gate 63e is 8 mm, and the safety cap 68 shall be tighten onto the valve-setting threaded ring 67 for a double hermetic close.

The MVV 60 in the present disclosure differs from the vacuum miniature piston valves (VMPV) of U.S. Pat. Nos. 10,443,298 and 10,443,299 due to its imperfections that depend on the machining accuracy of the piston and cylinder, and another problem is that air may be momentarily introduced while the vacuum pump hose adapter 71 is being disconnected after evacuation, potentially reduce the vacuum level.

Whereas, in the present invention, the vacuum gasket F217 64 is introduced to ensure hermetic shut, and the required minimum pressure of the spring was calculated according to Pascal's principle is 5.07 N, if opening diameter is 8 mm but adding safety value it is favorably 10 N or more for the actual value, so that the evacuating process can be safely performed by simply disconnecting the vacuum hose adapter.

### Evacuation Process

Referring to FIG. 7, the arrows show air flow when the piston shaft 63b is being pushed down to open the vacuum gate 63e by pusher 71 of vacuum hose adapter when it is connected to the MVV 60.

The vacuum gap is 18 mm~24 mm which may be the least space to adjust high or diameter of MVV 60. If the vacuum gap is 24 mm high, U-value can be lowered to about 0.1 W/m² K or less which is not yet available in marketing and can be guaranteed lifelong service.

While the invention has been described in connection with what is presently considered to be the best practical and preferred embodiments with lowest U-value, it is to be understood that the invention is not to be limited to the disclosed embodiments, but on the contrary, is intended to cover various modifications and equivalent arrangements included within the spirit and scope of the appended claims.

What is claimed is:

1. A vacuum insulated glass (VIG) panel comprising:
first and second glass substrates spaced apart by a predetermined distance;
a module comprising glass strips as spacers and a glass strip rectangular wall, disposed between the first and second glass substrates;
a rectangular glass strip wall, interconnected with the first and second glass substrates by periphery welding, define a vacuum space; and
a micro vacuum valve (MVV), mounted into the vacuum space through a hole either at the corner of the first glass substrate or mid of any side of the rectangular glass strip wall, to evacuate the vacuum space.

2. The VIG panel of claim 1, wherein the first and second glass substrates are tempered float glass of 4 to 6 mm thick and dimension of 9300 mm by 2100 mm in these embodiments.

3. The VIG panel of claim 1, wherein the glass strips are tempered; both ends of the glass strips are tapered to prevent heat damage during welding; each of the glass strips has multiple feet to facilitate air flow therebetween in the vacuum space; and the vertical glass strips are designed with multiple u-shaped slits, and the parallel glass strips are designed with inverted multiple u-shaped slits or vice versa, enabling them to cross-join into a lattice structure forming a rectangular glass strip wall.

4. The VIG panel of claim 1, wherein the module comprises multiple glass strips cross-joined in a lattice structure; and a rectangular glass strip wall being joined together; and disposed between said the first and second glass substrates.

5. The VIG panel of claim 1, wherein the VIG panel size of 2100 mm by 930 mm; two parallel glass strips and two vertical glass strips crossed as lattice structure into a total of 9 sections of each size of 700 mm by 310 mm, that supports the vacuum pressure about 1.95×10⁵ N along with a rectangular glass strip side wall.

6. The VIG panel of claim 1, wherein the MVV comprises a cylinder, a tail ring, a piston, a piston shaft, a vacuum passage gate plate, a piston shaft guider, a vacuum gasket F-217, a spring, a gasket ring, inside and outside threaded ring and a safety cap.

7. The VIG panel of claims 6, wherein the MVV secured by a threaded ring, to which a vacuum pump adapter is connected, wherein the piston shaft being pushed down by the pusher of the vacuum hose adapter to open a vacuum gate to evacuate the vacuum space.

8. The VIG panel of claim 7, wherein during the evacuation process, the vacuum gate must be closed by a spring force of 10 N or more if the diameter of the vacuum gate is 8 mm, before disconnecting the vacuum hose adapter; and afterwards, tighten the safety cap to seal the entire MVV again.
